(19) United States
(12) Patent Application Publication
(10) Pub. No.: US 2016/0349564 A1
(43) Pub. Date: Dec. 1, 2016

(54) DISPLAY DEVICE

(71) Applicant: Japan Display Inc., Tokyo (JP)

(72) Inventors: Osamu NAGASHIMA, Tokyo (JP); Hiroaki ASUMA, Tokyo (JP)

(21) Appl. No.: 15/146,931

(22) Filed: May 5, 2016

(30) Foreign Application Priority Data
Jun. 1, 2015 (JP) 2015-111320

(51) Int. Cl. G02F 1/1345; G02F 1/1333

(52) U.S. Cl. CPC G02F 1/13452; G02F 1/133345

(57) ABSTRACT

A display device includes a display area and the terminal area. Formed in the terminal area are FOG terminals connected to external wires and COG input terminals and COG output terminals connected to a semiconductor chip, the FOG terminals being connected to the COG input terminals, the COG output terminals being connected to lead wires extending from wires in the display area. The FOG terminals and the COG input terminals are structured so that a first ITO film is formed on a first terminal metal, the first ITO film having an insulating film formed thereon, the insulating film having first through holes formed therein to expose the first ITO film. The COG output terminals are structured so that the insulating film is formed on a second terminal metal, the insulating film having second through holes formed therein to expose the second terminal metal covered by a second ITO film.

### CLAIM OF PRIORITY

The present application claims priority from Japanese Patent Application JP 2015-111320 filed on Jun. 1, 2015, the content of which is hereby incorporated by reference into this application.

### BACKGROUND OF THE INVENTION

1. Field of the Invention

The present invention relates to a display device. More particularly, the invention relates to a liquid crystal display device that has an increasing number of terminals in its terminal area for high resolution purposes and still has the connection of the terminal area improved in reliability.

2. Description of the Related Art

Liquid crystal display devices are generally configured to have a thin-film transistor (TFT) substrate disposed opposite to a counter substrate with liquid crystal sandwiched therebetween, the TFT substrate having pixel electrodes and TFTs formed thereon in a matrix pattern for example. The display device forms an image by suitably controlling the light transmission factor of liquid crystal molecules for each pixel.

The liquid crystal device typically has a semiconductor chip that acts as a driver connected to the terminals formed on the TFT substrate via an anisotropic conductive film, for example. The connection is accomplished by thermocompression bonding using a bonding tool. At the time of thermocompression bonding, there must be a sufficient degree of parallelism between the bottom face of the bonding tool and the semiconductor chip. Otherwise, a connection defect may occur between the semiconductor chip and terminals on the TFT substrate.

JP-A-1999-282002 discloses a configuration in which dummy terminals are formed on both the semiconductor chip and the TFT substrate to maintain parallelism therebetween and to improve the degree of parallelism between the bottom face of the bonding tool and the semiconductor chip at the time of thermocompression bonding. Connection defects are prevented by this configuration.

### SUMMARY OF THE INVENTION

Typically, a display area and a terminal area are formed on a liquid crystal display device. Connected to the terminal area are a semiconductor chip for driving the liquid crystal display device and a flexible wiring substrate for externally supplying power and video signals, for example, to the semiconductor chip. The semiconductor chip is connected to the terminals formed on the TFT substrate using an anisotropic conductive film, for example, in what is known as a chip-on-glass (COG) structure. The flexible wiring substrate is also connected to the terminals formed on the TFT substrate using an anisotropic conductive film, for example, in what is known as a film-on-glass (FOG) structure.

The higher the resolution of the screen becomes, the larger the numbers of wires and terminals that need to be installed. The terminals are formed by having through holes etched in an insulating film that covers a terminal metal portion formed at the edge of lead wires, thereby exposing a terminal metal for terminal formation. Where the number of terminals is limited, the terminal area is etched by wet etching. As the number of terminals increases, it is necessary to use dry etching involving a gas.

The terminal metal and the gas coming into contact therewith at the time of dry etching can form a high-resistance film over the terminal metal surface depending on their combination. The high-resistance film formed over the terminal metal produces a voltage drop resulting in a malfunction.

It is therefore an object of the present invention to provide a highly reliable high-image-quality display device that prevents a high-resistance film from being produced over a terminal area formed by dry etching.

The present invention proposes achieving the above object by use of specific means outlined below.

(1) According to one embodiment of the present invention, there is provided a display device includes a display area and the terminal area. Formed in the terminal area are FOG terminals connected to external wires and COG input terminals and COG output terminals connected to a semiconductor chip, the FOG terminals being connected to the COG input terminals, the COG output terminals being connected to lead wires extending from wires in the display area. The FOG terminals and the COG input terminals are structured so that a first indium tin oxide (ITO) film is formed on a first terminal metal, the first ITO film having an insulating film formed thereon, the insulating film having first through holes formed therein to expose the first ITO film. The COG output terminals are structured so that the insulating film is formed on a second terminal metal, the insulating film having second through holes formed therein to expose the second terminal metal covered by a second ITO film.

(2) Preferably in the display device described in the paragraph (1) above, the first terminal metal and the second terminal metal may have titanium (Ti) formed on the surfaces thereof.

(3) Preferably in the display device described in the paragraph (1) above, the first terminal metal and the second terminal metal may have a cap metal formed on an aluminum (Al) alloy, the cap metal being constituted by Ti.

(4) Preferably in the display device described in the paragraph (1) above, the insulating film may be constituted by silicon nitride (SiNx).

(5) Preferably in the display device described in the paragraph (1) above, the first through holes and the second through holes may be formed by dry etching.

(6) Preferably in the display device described in the paragraph (5) above, the dry etching may involve use of a sulfur hexafluoride (SF6) gas.

(7) Preferably in the display device described in the paragraph (1) above, the first ITO film may be formed at the same time as first electrodes in pixels in the display area, and the second ITO film may be formed at the same time as second electrodes in the pixels in the display area.

(8) According to another embodiment of the present invention, there is provided a display device including a display area and a terminal area. The terminal area has FOG terminals, COG input terminals, and COG output terminals formed therein, the FOG terminals being connected to external wires, the COG input terminals and the COG output terminals being connected to a semiconductor chip. The FOG terminals are connected to the COG input terminals. The COG output terminals are connected to lead wires extending from wires in the display area. The lead wires include long lead wires and short lead wires. The COG output terminals connected to the short lead wires are structured in such a manner that a first ITO film is formed on a first terminal metal, the first ITO film having an insulating film formed thereon, the insulating film having first through holes formed therein to expose the first ITO film. The COG output terminals connected to the long lead wires are structured in such a manner that the insulating film is formed on a second terminal metal, the insulating film having second through holes formed therein to expose the second terminal metal that is covered by a second ITO film.

(9) Preferably in the display device described in the paragraph (8) above, the FOG external terminals and the COG input terminals may be structured in such a manner that the first ITO film is formed on a third terminal metal, the first ITO film having the insulating film formed thereon, the insulating film having third through holes formed therein to expose the first ITO film.

### BRIEF DESCRIPTION OF THE DRAWINGS

FIG. 1 is a plan view of a liquid crystal display device as one embodiment of the present invention;

FIG. 2 is a magnified view of a terminal area;

FIG. 3 is a plan view of an FOG terminal or a COG input terminal;

FIG. 4 is a cross-sectional view taken on line A-A in FIG. 3;

FIG. 5 is a plan view of a COG output terminal;

FIG. 6 is a cross-sectional view taken on line B-B in FIG. 5;

FIG. 7 is a magnified view of a terminal area of another embodiment of the present invention; and

FIG. 8 is a cross-sectional view illustrating a problem specific to a traditional terminal structure and targeted for solution by the present invention.

### DESCRIPTION OF THE PREFERRED EMBODIMENTS

The specifics of the present invention are described below using preferred embodiments.

### First Embodiment

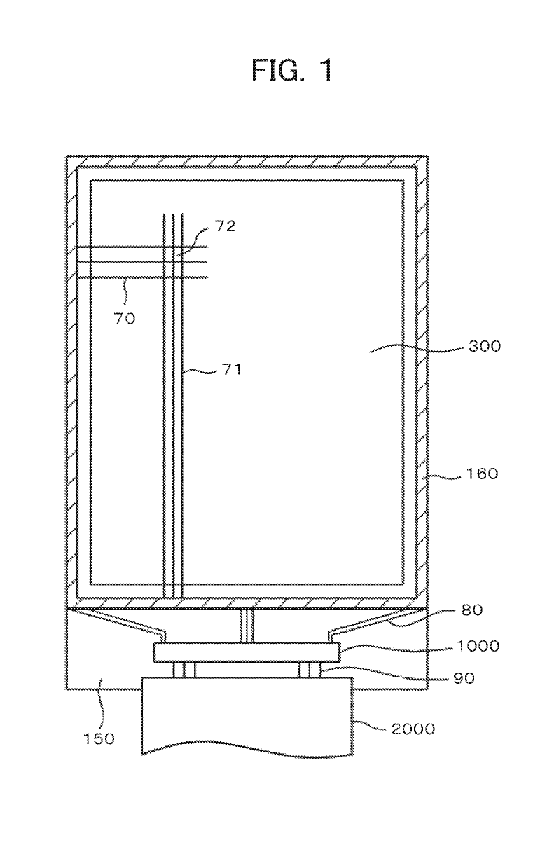

FIG. 1 is a plan view showing a typical liquid crystal display panel to which the present invention is adapted. In FIG. 1, a TFT substrate 100 and a counter substrate 200 are bonded together by a sealant 160 with liquid crystal sandwiched therebetween. The bonded portion constitutes a display area 300. The TFT substrate 100 is formed to be larger than the counter substrate 200. That portion of the TFT substrate 100 which is not covered with the counter substrate 200 constitutes a terminal area 150.

Over the display area 300, scanning lines 70 extend in a crosswise direction and are arrayed at a first pitch in a longitudinal direction. Video signal lines 71 extend in the longitudinal direction and are arrayed at a second pitch in the crosswise direction. The portions enclosed by the scanning lines 70 and the video signal lines 71 constitute pixels 72. This specification primarily explains what is known as an in-plane-switching (IPS) system liquid crystal display device that provides good viewing angle characteristics. However, this type of liquid crystal display device is not limitative of the present invention. The invention can also be applied to other types of liquid crystal display devices and to organic electroluminescent (EL) display devices, for example.

In the case of the IPS system, first electrodes formed flat using a transparent conductive film constituted by indium tin oxide (ITO) for example, are covered by one or a plurality of linear (combed-tooth-shaped) or slit-formed second electrodes constituted by ITO for example, with an interlayer insulating film interposed therebetween. A voltage representing the video signal is impressed between the first and the second electrodes to drive the liquid crystal. Each pixel is formed of a thin-film transistor (TFT), a first electrode, and a second electrode, for example.

The terminal area 150 is connected with a semiconductor chip 1000 that drives the liquid crystal display panel, via an anisotropic conductive film interposed therebetween for example. Because the semiconductor chip 1000 is placed typically on a glass substrate, this structure is called a chip-on-glass (COG) structure. Also connected to the terminal area 150 is a flexible wiring substrate 2000 typically via an anisotropic conductive film interposed therebetween, the substrate 2000 supplying power and signals to the semiconductor chip 1000. The scanning lines 70 and video signal lines 71 of the display area 300 are connected to the semiconductor chip 1000 by lead wires 80. The flexible wiring substrate 2000 is connected to the semiconductor chip 1000 by connecting wires 90.

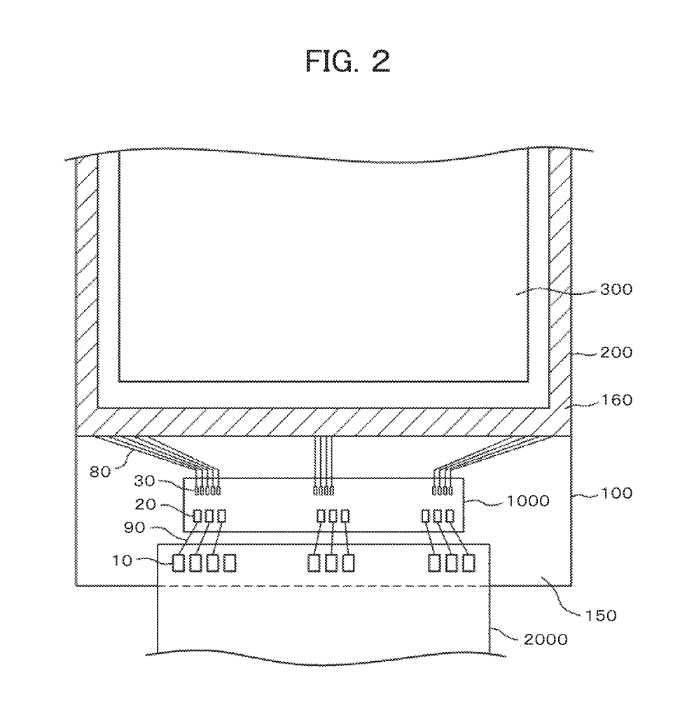

FIG. 2 is a magnified view showing the terminal area 150 in FIG. 1. In FIG. 2, output terminals 30 coming from the semiconductor chip 1000 and input terminal 20 leading thereto are formed over that portion of the TFT substrate 100 which corresponds to the semiconductor chip 1000. The semiconductor chip 1000 has bumps formed thereon corresponding to the output terminals 30 and the input terminals 20. There are as many output terminals 30 as the number of scanning lines 70 and video signal lines 71 over the display area 300. That means there are a very large number of output terminals 30 (e.g., 1000 or more). By contrast, the input terminals 20 are provided as many as the number of terminals 10 connected to the wires on the flexible wiring substrate 2000. That means there are about twenty to thirty input terminals 20, for example. The output terminals 30 coming from the semiconductor chip 1000 are thus smaller in size and terminal-to-terminal pitch than the input terminals 20 leading to the semiconductor chip 1000.

In FIG. 2, the terminals 10 (called the external terminals or the FOG terminals below because of their use on the film on glass (FOG)) connected to the flexible wiring substrate 2000 are as few as twenty to thirty in number. Given their small number, the terminals 10 can be formed to be larger in size and terminal-to-terminal pitch than the output terminals 30 (called the COG output terminals below because they come from the chip-on-glass (COG) semiconductor chip). Also, the FOG terminals 10 are given a larger terminal space than the input terminals 20 (called the COG input terminals below because they lead to the chip-on-glass (COG) semiconductor chip) or the COG output terminals 30. The larger terminal space allows the FOG terminals 10 to be formed larger in size and terminal-to-terminal pitch than the COG input terminals 20 or the COP output terminals 30.

The terminals are formed by having through holes etched in that portion of an insulating film (interlayer insulating film) which corresponds to the terminal metals formed at the end of the lead wires or the connecting wires produced under the insulating film. Via the etched through holes, the lead wires or the connecting wires constituted by a metal or an alloy are exposed. The exposed parts are covered with an ITO-constituted transparent conductive film, for example. In many cases, the interlayer insulating film is constituted by silicon nitride (SiNx). The through holes used to be formed by wet etching. With the terminals becoming smaller in size, however, they are generally formed by dry etching that permits higher fineness. Dry etching involves the use of a gas such as sulfur hexafluoride (SF6).

The larger the number of lead wires 80 or that of connecting wires 90, the narrower their wire width. An aluminum (Al) alloy such as AlNb, AlSi or AlCu is used to form the lead wires 80 or the connecting wires 90 in order to minimize an increase in their resistance. The use of the Al alloy can result in hillock formation or cause a faulty connection with an ITO film. To prevent such a failure, titanium (Ti) is often used as a cap metal over the Al alloy. In many cases, the lead wires or the connecting wires in that structure are formed at the same time as the video signal lines.

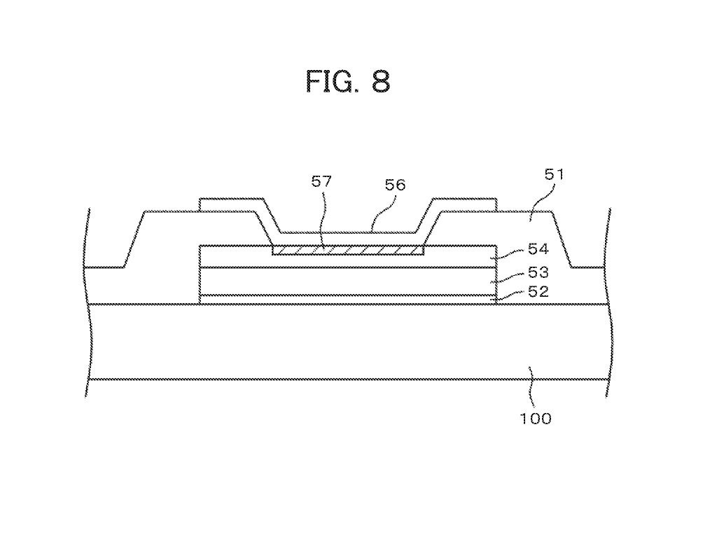

FIG. 8 is a cross-sectional view showing a terminal area indicative of a problem with the above-described structure. In FIG. 8, terminal metals are disposed on the TFT terminal 100. In turn, an interlayer insulating film 51 is disposed as a protective film over the terminal metals. The terminal metals are formed of a Ti-constituted base metal 52, an Al alloy 53, and a cap metal 54. In the terminal area, the interlayer insulating film 51 is etched with a gas containing SF6 to form through holes in the film 51 and thereby expose the cap metal 54 from the terminal metals. Thereafter, the terminal area is covered with a second ITO film constituting the above-mentioned second electrodes in the pixels. The second ITO film protects the terminal metals against corrosion.

The problem with the structure in FIG. 8 is that during dry etching, the SF6-containing gas reacts with titanium (Ti) to form a high-resistance film 57. The high-resistance film 57 causes a voltage drop in the terminal area. This is a particularly serious problem with the supply of a direct current (DC) power source, for example. That is, in FIG. 2, the flexible wiring terminal 2000 supplies DC voltages to power the semiconductor chip 1000 from the FOG terminals 10 to the COG input terminals 20 of the semiconductor chip 1000. If a high-resistance film is formed over the terminal area, a voltage drop caused thereby in the terminal area may stop the supply of the voltage necessary for operating the semiconductor chip 1000.

Meanwhile, the liquid crystal display device driven by alternate currents (AC) is supplied via the COG output terminals 30 with signals that vary periodically in polarity and voltage. The AC drive produces a capacity coupling at the terminals. That means the voltage drop is not as serious a problem with the COG output terminals 30 as with the FOG terminals 10 or the COG input terminals 20. Whereas the FOG terminals 10 or the COG in terminals 20 are larger in size and terminal-to-terminal pitch than the COG output terminals 30, the FOG terminals 10 and the COG input terminals 20 are to be dry-etched in the same manner as the COG output terminals 30 that need to be dry-etched.

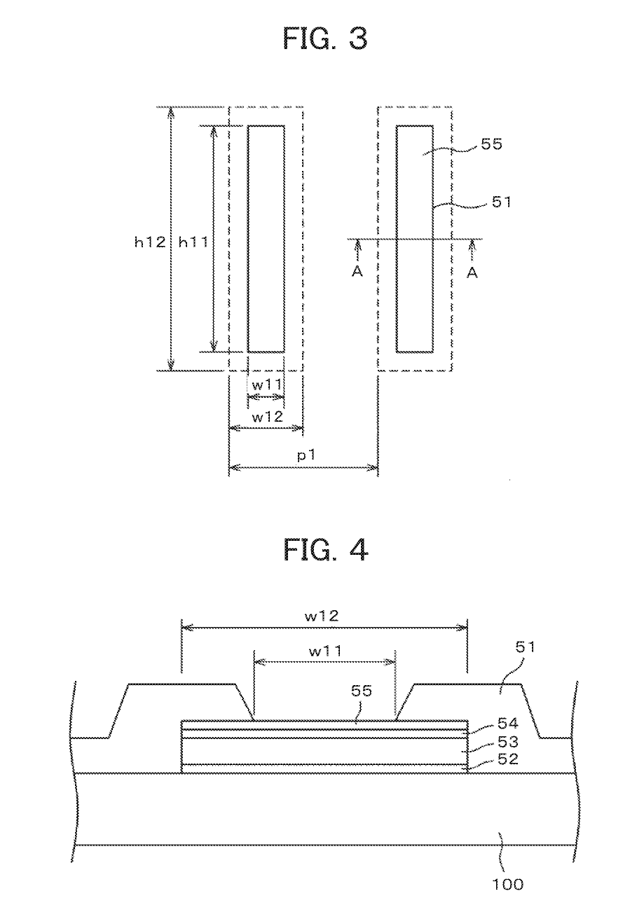

FIG. 3 is a plan view of an FOG terminal 10 and a COG input terminal 20 devised to counter the above problem according to the present invention. Table 1 below lists typical dimensions of the FOG terminal 10 and COG input terminal 20 when viewed in a plan view. A terminal-to-terminal pitch P1 in FIG. 3 is defined as 2w×11<p1≦2×w12.

TABLE 1

| | FOG terminal (μm) | COG input terminal (μm) |
|---|---|---|
| w11 | 49 | 22 |
| w12 | 55 | 28 |
| h11 | 489 | 131 |
| h12 | 500 | 148 |

FIG. 4 is a cross-sectional view taken on a line in FIG. 3. The terminal structure in FIG. 4 is markedly different from the traditional terminal structure in that the ITO film protecting the terminal metals is not disposed in a manner covering the through holes but formed under the through holes or below the interlayer insulating film 51. The terminal metal composition is the same as explained above in reference to FIG. 8. The ITO film 55 in the structure of FIG. 4 is a first ITO film 55 formed at the same time as the first electrodes in the pixels. Because the first ITO film 55 is formed simultaneously with the first electrodes in the pixels, the number of manufacturing steps involved is not increased.

In FIG. 4, the first ITO film 55 is patterned, before being covered with SiNx constituting the interlayer insulating film 51. The interlayer insulating film 51 is in turn is dry-etched to form through holes in the terminal area. At this time, the gas used in dry etching comes into contact with the first ITO film but not with titanium (Ti), so that a high-resistance film as a Ti compound is not produced. Thus the voltage drop in the terminal area is prevented. Since the terminal metals are already covered by the first ITO film, there is no need to cover them with a second ITO film.

In FIG. 4, the terminal metals are formed of the AI alloy 53 sandwiched between the base metal 52 and the Ti-constituted cap metal 54. However, the base metal 52 that does not react with the dry etching gas is not indispensable for the structure according to the invention.

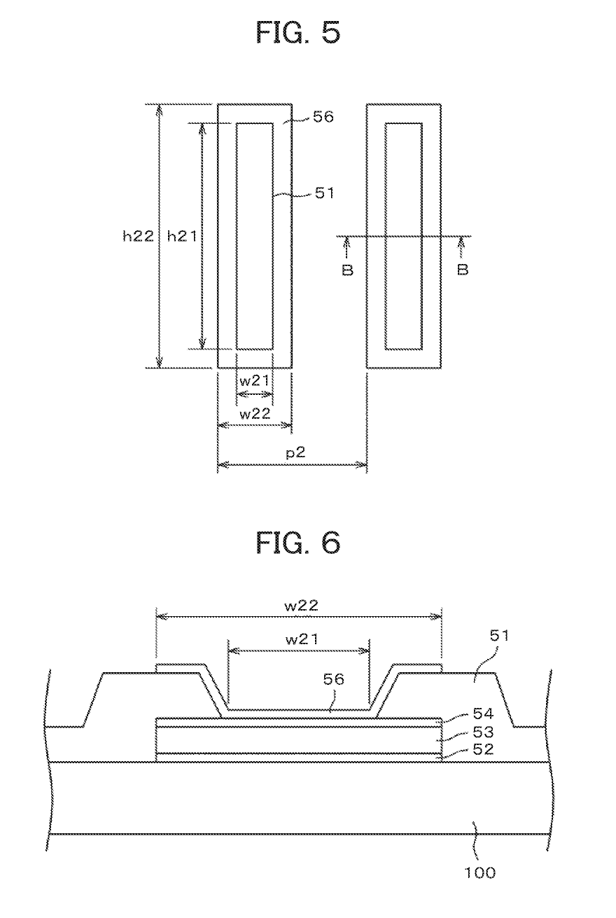

FIG. 5 is a plan view of a COG output terminal. Table 2 below lists typical dimensions of the terminal shown in FIG. 5. A terminal-to-terminal pitch P2 in FIG. 5 is defined as 2×w21<p2≦2×w22.

TABLE 2

| | COG output terminal (μm) |
|---|---|
| w21 | 9 |
| w22 | 26 |
| h21 | 94 |
| h22 | 118 |

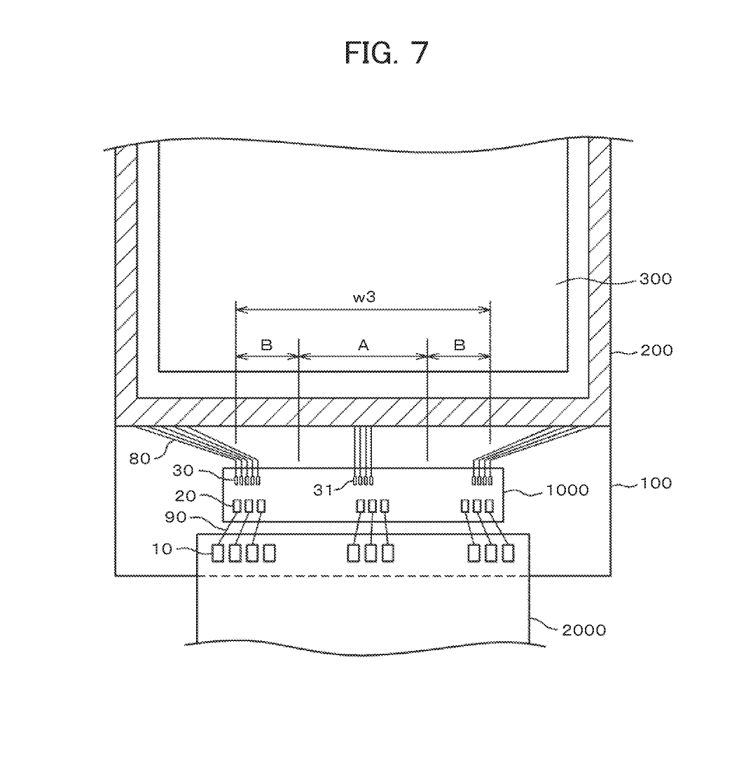

FIG. 6 is a cross-sectional view taken on line B-B in FIG. 5. The structure in FIG, 6 is basically the same as that in FIG. 8 except that the structure in FIG. 6 is devoid of a high-resistance film. A specific terminal metal (e.g., Ti) reacts with a specific gas (e.g., SF6) during dry etching to form a high-resistance film over the terminal metal surface. If the COG output terminals 30 are structured to have the cross section shown in FIG. 4, they have a reduced planar dimension coming into contact with the anisotropic conductive film for example, thereby increasing the resistance in the terminal area.

On the other hand, only AC voltages pass through the COG output terminals 30. That means the capacity coupling of the COG output terminals 30 ensures connectivity even if a high-resistance film is formed on the terminals. This prevents the voltage drop from becoming as serious a problem as with the FOG terminals 10 or with the COG input terminals 20. This embodiment thus adopts the structure in FIG. 5 or 6 with the terminal resistance not increased in the COG output terminals 30.

FIG. 6 shows a structure in which an Al alloy 53 is sandwiched between a Ti-constituted base metal 52 and a Ti-constituted cap metal 54. In this case, too, the base metal 52 that does not react with the dry etching gas is not indispensable for the inventive structure.

As described above, this embodiment prevents the high-resistance film from being formed over at least the FOG terminals 10 and the COG input terminals 20 while forestalling the increase of terminal resistance in the COG output terminals 30. This contributes to manufacturing a highly reliable liquid crystal display device.

The foregoing description was based on the assumption that titanium (Ti) on the terminal metal surface produces a high-resistance film over that surface upon reaction with an SF6-containing dry etching gas during the dry etching process. Where the terminal metals include a metal other than Ti or where the dry etching gas contains a gas other than SF6, a high-resistance film could also be produced over the terminal metal surface. In such a case, the present invention proposes using the structure shown in FIG. 3 or 4 for the FOG terminals 10 and the COG input terminals 20 in combination with the structure indicated in FIG. 5 or 6 for the COG output terminals 30. The advantageous effect of the combined structures is still the same as discussed above.

### Second Embodiment

FIG. 7 is a magnified view of the terminal area of a liquid crystal display device as a second embodiment of the present invention. The structure in FIG. 7 is basically the same as that in FIG. 2. The difference is that in FIG. 7, the structure of the COG output terminals 30 is changed depending on their position over the semiconductor chip 1000. That is, in FIG. 7, a region indicated by A approximately in the middle on the semiconductor chip 1000 carries differently structured COG output terminals 31 while two regions indicated by B on both sides of the region A bear the COG output terminals 30 shown in FIG. 6. The cross-sectional shape of the COG output terminals 31 is the same as that in FIG. 4 except that the dimension w11 in FIG. 4 is 9 μm and w12 is 26 μm, for example.

Where a high-resistance film is not formed over the terminal metal surface, the terminal shown in FIG. 6 has a lower resistance than the terminal in FIG. 4. That is because the planar dimension of each terminal connected to a bump on the semiconductor chip via an anisotropic conductive film interposed therebetween is larger than the planar dimension of each COG output terminal 31 as a variation of the COG output terminal 30. In practice, however, dry etching carried out on the structure of FIG. 6 produces a high-resistance film that causes a higher terminal resistance.

However, as explained above in conjunction with the first embodiment, the COG output terminals let pass the signals that periodically vary in voltage and polarity. This produces the capacity coupling that prevents a prominent voltage drop from occurring even if a high-resistance film is formed. Meanwhile, in the case of the capacity coupling, the planar dimension of each terminal significantly affects the resistance of the terminal area. Thus where only AC voltages pass through, the COG output terminals 30 render the terminal area resistance lower than the COG output terminals 31.

Meanwhile, the lead wires 80 are longer in the regions B than in the region A in FIG. 7. That is, the resistance of the lead wires 80 is higher in the regions B than in the region A. As a result, the intensity of the video signal, for example, actually impressed to the pixels is varied between the region A and the regions B. This can lead to brightness irregularities on the screen, for example.

The second embodiment renders the terminal area resistance of the COG output terminals 31 higher than the resistance of the COG output terminals 30. The effect on the video signal, for example, is defined as the sum of the terminal area resistance and the lead wire resistance. Because the second embodiment reduces the difference between the region A and the regions B in terms of the sum of the terminal area resistance and the lead wire resistance, the intensity of the video signal, for example, impressed to the pixels is homogenized. That in turn contributes to homogenizing the brightness of the screen.

If, in FIG. 7, w3 is assumed to represent the distance between the rightmost and the leftmost COG. output terminals 30, then w3/2 denotes the width of the region A. where the COG output terminals 31 are formed, and w3/4 stands for the width of each region B where the COG output terminals 30 are formed. It should be noted that the widths of the regions A and B may be optimized depending on the lengths of the lead wires 80 or on the layout conditions.

In FIG. 7, the center of the long side dimension of the semiconductor chip 1000 coincides with the center of the display area 300. Depending on the liquid crystal display device, the semiconductor chip 1000 may have its center not aligned with the center of the display area 300. In such a case, the COG output terminals connected to the longer lead wires 80 may be structured as shown in FIG. 5 or 6, and the COG output terminals connected to the shorter lead wires 80 may be structured as illustrated in FIG. 3 or 4.

In the second embodiment, the second ITO film is used to protect the terminal metals for the COG output terminals 30, and the first ITO film is used to protect the terminal metals for the COG output terminals 31. The first ITO film is formed at the same time as the first electrodes in the pixels, and the second ITO film is formed simultaneously with the second electrodes in the pixels. That means there is no increase in the number of manufacturing steps involved. In the second embodiment, too, the FOG terminals 10 or the COG input terminals 20 should preferably be structured as shown in FIG. 3 or 4.

As described above, the second embodiment minimizes brightness irregularities of the screen, for example, by preventing an increase in the DC resistance of the terminal area and by better homogenizing the sum of the terminal area resistance and the lead wire resistance with regard to the video signal lines that vary periodically in polarity and voltage in the central and peripheral regions of the screen.

The foregoing paragraphs have explained the liquid crystal display device as an example of the present invention. However, this is not limitative of the present invention. Other display devices to which this invention may be adapted advantageously include an organic EL display device, for example, in which the semiconductor chip in the COG structure or the flexible wiring substrate in the FOG structure is connected to a TFT substrate or to a device substrate (i.e., a substrate on which the light-emitting devices for an organic EL display device are formed). The COG output terminals may be connected to the video signal lines not directly but via red/green/blue (RGB) switches (selectors) interposed therebetween. The COG output terminals may be connected to the scanning lines not directly but by way of TFT-based scanning line drive circuits formed over the TFT substrate, the scanning line drive circuits being supplied with a clock signal for example. In this case, the terminals that supply the video signal to the video signal lines may be formed in the above-described COG output terminal structure, and the terminals that feed the clock signal and power to the scanning line drive circuits may be given the same structure as the above-described COG input terminals. Alternatively, the terminals that supply the clock signal to the scanning line drive circuits may be given the same structure as the above-described COG output terminals, and the terminals that supply power may have the same structure as the above-described COG input terminals. The first ITO film and the second ITO film used in the organic EL display device may each be an ITO film used as cathode or anode electrodes sandwiching organic EL light-emitting devices.

What is claimed is:

1. A display device comprising:
a display area; and
a terminal area,
wherein the terminal area has external terminals, input terminals, and output terminals, the external terminals being connected to a flexible wiring substrate, the input terminals and the output terminals being connected to a semiconductor chip;
the external terminals are electrically connected to the input terminals;
the output terminals are connected to lead wires supplying signals to wires in the display area;
the external terminals and the input terminals have a first metal, a first transparent conductive film is formed on the first metal, and an insulating film formed on the first transparent conductive film, the insulating film having first through holes formed therein to expose the first transparent conductive film; and
the output terminals have a second metal, and a second transparent film formed on the second metal, the insulating film is disposed between the second metal and the second transparent film and has second through holes covered by the second transparent film.

2. The display device according to claim 1, wherein the first metal and the second metal have titanium.

3. The display device according to claim 1, wherein the first metal and the second metal have a cap metal formed on an aluminum alloy, the cap metal has titanium.

4. The display device according to claim 1, wherein the insulating film has silicon nitride.

5. The display device according to claim 1, wherein the first through holes and the second through holes are formed by dry etching.

6. The display device according to claim 5, wherein the dry etching involves use of a sulfur hexafluoride gas.

7. The display device according to claim 1, wherein the first transparent conductive film is formed at the same time as first electrodes in pixels in the display area, and the second transparent conductive film is formed at the same time as second electrodes in the pixels in the display area.

8. A display device comprising:
a display area; and
a terminal area,
wherein the terminal area has external terminals, input terminals, and output terminals, the external terminals being connected to external wires, the input terminals and the output terminals being connected to a semiconductor chip;
the external terminals are electrically connected to the input terminals;
the output terminals are connected to lead wires supplying signals to wires in the display area;
the lead wires include first lead wires and second lead wires shorter than the first lead wires;
the output terminals connected to the second lead wires have a first metal, a first transparent conductive film formed on the first terminal metal, and an insulating film formed on the first transparent conductive film, the insulating film having first through holes formed therein; and
the output terminals connected to the first lead wires have a second terminal metal, and a second transparent film formed on the second metal the insulating film is disposed between the second metal and the second transparent film and has second through holes covered by a second transparent conductive film.

9. The display device according to claim 8, wherein the first metal and the second metal have titanium.

10. The display device according to claim 8, wherein the first metal and the second metal have a cap metal formed on an aluminum alloy, the cap has titanium.

11. The display device according to claim 8, wherein the insulating film is silicon nitride.

12. The display device according to claim 8, wherein the first through holes and the second through holes are formed by dry etching.

13. The display device according to claim 12, wherein the dry etching involves use of a sulfur hexafluoride gas.

14. The display device according to claim 8, wherein the first transparent conductive film is formed at the same time as first electrodes in pixels in the display area, and the second transparent conductive film is formed at the same time as second electrodes in the pixels in the display area.

15. The display device according to claim 8, wherein the external terminals and the input terminals are structured in such a manner that the first transparent conductive film is formed on a third terminal metal, the insulating film is formed on the first transparent film, the insulating film having third through holes formed therein to expose the first transparent conductive film.

16. The display device according to claim 1, wherein the display area constitutes a liquid crystal display device.

17. The display device according to claim 8, wherein the display area constitutes a liquid crystal display device.
